(19) United States
(12) Patent Application Publication
(10) Pub. No.: US 2007/0080489 A1
(43) Pub. Date: Apr. 12, 2007

(54) Fixture for bonding workpieces

(75) Inventor: Shih-Chieh Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/432,971

(22) Filed: May 12, 2006

(30) Foreign Application Priority Data
Sep. 23, 2005 (CN) 200510037478.2

(51) Int. Cl. B23Q 3/00

(52) U.S. Cl. 269/296

(57) ABSTRACT

A fixture (10) for bonding workpieces (14) includes a frame (12) and a supporting board (13). The frame includes a first side wall (121), a second side wall (122), and a third side wall (123). The first side wall is opposite to the second side wall, and the third side wall connects the first side wall and the second side wall. The supporting board is slideably associated with the first side wall and the second side wall. The first side wall and the second side wall respectively have a slideway (124) associated with the supporting board. The slideways of the first side wall and the second side wall are opposite to each other.

### TECHNICAL FIELD

The present invention generally relates to apparatuses for cylindrically grinding workpieces and, more particularly, to a fixture for bonding workpieces.

### BACKGROUND

Usually, optical elements such as camera lenses and spectacles are in used in cylindrical form. However, original optical workpieces (i.e. lens blanks) are most easily manufactured in the form of a square. Therefore, these original optical workpieces have to be cylindrically ground before use.

A typical example of a contemporary cylindrical grinding apparatus is a centering apparatus. The centering apparatus typically includes a pair of holders for holding the original workpiece, where each holder has a hollow chamber communicating with a surface of the holder. The holder can hold the workpiece on its surface by using an air pump creating suction in the hollow chamber, a grinding wheel is then used to cylindrically grind the workpiece. However, the centering apparatus can only cylindrically grind one workpiece at a time.

FIGS. 5-6 show an apparatus for cylindrically grinding more than one workpiece at a time. The apparatus includes a first holding tool 30 and a second holding tool 40. The first holding tool 30 defines a holding groove 32, and the second holding tool 40 defines a semicircular groove 42. The holding groove 32 and the semicircular groove 42 are both for securing the workpieces 50 in the holding tools 30, 40. In use, firstly, a plurality of workpieces 50 are placed in the holding groove 32 of the first holding tool 30. Secondly, the workpieces 50 are bonded together using adhesive. Thirdly, a grinding wheel is used to grind a portion of the workpieces 50 projecting out of the holding groove 32 into a semicircular shaped portion 51. Fourthly, the semicircular portion 51 of each workpiece 50 is transferred to the semicircular groove 42 of the second holding tool 40. Fifthly, the remaining portions of the workpieces 50 are also ground into a semicircular shape using the grinding wheel. The final result being that the workpieces 50 are ground into a cylindrical shape.

When transferring the workpieces 50 from the first holding tool 30 to the second holding tool 40, the adhesive should be dissolved so that the workpieces 50 can be taken out of the first holding tool 30. However, the workpieces 50 will not be compact (i.e. held together in a tight bundle) in the second holding tool 40 because the workpieces 50 will become disarrayed whilst the adhesive is being dissolved.

Therefore, a fixture for bonding workpieces which can overcome the above-described problems is desired.

### SUMMARY OF THE INVENTION

In one embodiment thereof, a fixture for bonding workpieces includes a frame and a supporting board. The frame includes a first side wall, a second side wall, and a third side wall. The first side wall is opposite to the second side wall, and the third side wall connects the first side wall and the second side wall. The supporting board is slideably fitted to the first side wall and the second side wall.

Other advantages and novel features will become more apparent from the following detailed description when taken in conjunction with the accompanying drawings.

### BRIEF DESCRIPTION OF THE DRAWINGS

Many aspects of the fixture for bonding workpieces can be better understood with reference to the following drawings. The components in the drawings are not necessarily drawn to scale, the emphasis instead being placed upon clearly illustrating the principles of the present fixture. Moreover, in the drawings, like reference numerals designate corresponding parts throughout the several views.

FIG. 1 is a schematic view of a fixture for bonding workpieces in accordance with a preferred embodiment;

FIG. 2 is an exploded, schematic view of the fixture for bonding workpieces in FIG. 1;

FIG. 3 is a schematic view of a fixture for bonding workpieces in accordance with another preferred embodiment;

FIG. 4 is an exploded, schematic view of the fixture for bonding workpieces in FIG. 3;

FIG. 5 is a schematic view of a first holding tool for cylindrically grinding workpieces from the prior art; and

FIG. 6 is a schematic view of a second holding tool for cylindrically grinding workpieces from the prior art.

### DETAILED DESCRIPTION OF THE EMBODIMENT

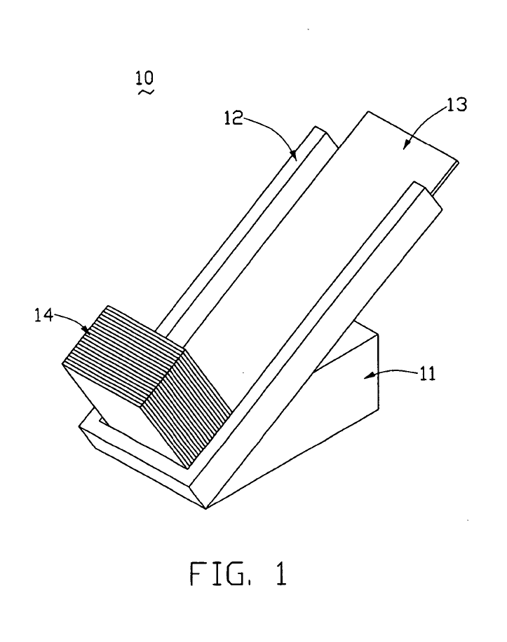

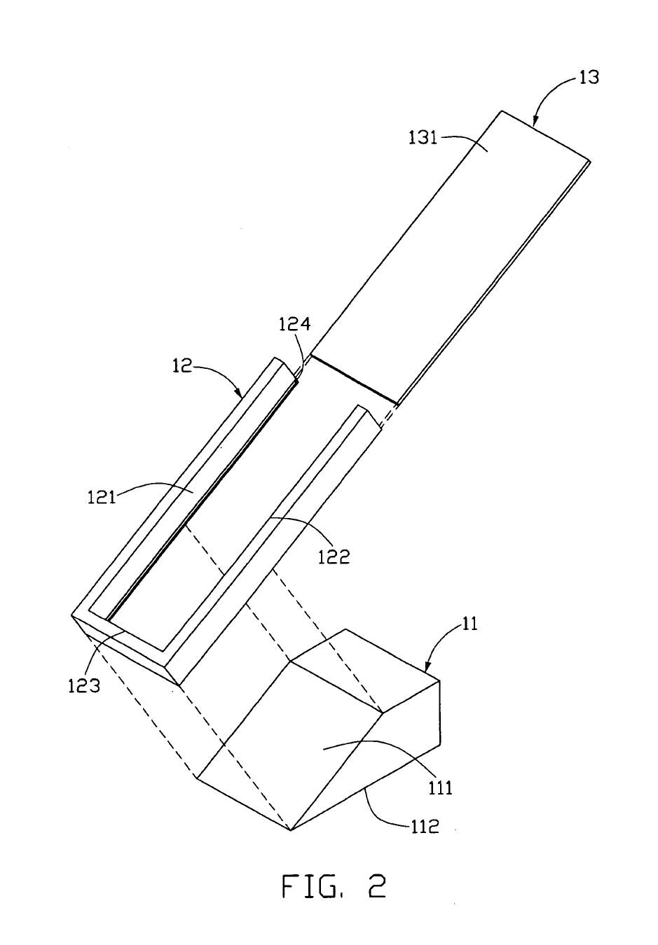

Referring to FIGS. 1-2, in a preferred embodiment, a fixture 10 for bonding workpieces 14, includes a supporting base 11, a frame 12, and a supporting board 13. The frame 12 is settled on the supporting base 11, and the supporting board 13 is slideably settled in the frame 12. The workpieces 14 are placed on the supporting board 13 in the frame 12.

The supporting base 11 has an undersurface 112 and an inclined plane 111. The undersurface 112 is parallel to the horizontal plane. The inclined plane 111 and the undersurface 112 form an angle 0 which may be in the range from 30 to 45 degrees. In this preferred embodiment, the supporting base 11 has a trapezoidal cross section. It may be understood that the supporting base 11 can also have a triangular cross section or any other appropriately shaped cross section.

In this embodiment, the frame 12 is substantially U-shaped and includes a first side wall 121, a second side wall 122, and a third side wall 123. The first side wall 121 is opposed and parallel to the second side wall 122, and the third side wall 123 perpendicularly interconnects the first side wall 121 and the second side wall 122 at one end. One of the first side wall 121 and the second side wall 122 has a slideway 124 for guiding the supporting board 13. It is understood that the frame 12 can be an inclined supporting member, and the third side wall 123 is a lower end portion relative to the first side wall 121 and the second side wall 122. The slideways 124 can be other positioning members. The third side wall can also have a slideway as positioning member cooperating with the slideways 124 to form a receiving space therebetween for receiving the bonding workpieces 14 therein.

The supporting board 13 is substantially a quadrate board, and has a width slightly greater than the distance between the first side wall 121 and the second side wall 122. The supporting board 13 has an upper surface 131 for supporting the workpieces 14. It is understood that the supporting base 11 can also be formed together with the frame 12 so that the supporting board 13 can settle aslant into the frame 12.

When using the fixture 10 for bonding workpieces 14, firstly, a predetermined amount of lubricating oil is smeared on the upper surface 131 of the supporting board 13. Secondly, the supporting board 13 is inserted into the frame 12 along the main axes of the slideways 124, whereby the frame and the supporting board cooperatively form a receiving space therebetween. Thirdly, a plurality of workpieces 14 are placed on the upper surface 131 of the supporting board 13, parallel to the third side wall 123. Fourthly, a predetermined amount of hydrolysable ultraviolet adhesive is dropped on to the workpieces 14, and bonds the workpieces 14 together. Finally, the supporting board 13 is detached from the frame 12, and the workpieces 14 are transferred to a cylindrical grinding apparatus for grinding.

The fixture 10 is easy to be used for bonding workpieces 14. Furthermore, the bonded workpieces 14 are easy to transfer to the cylindrical grinding apparatus because the workpieces 14 cannot be bonded with the lubricated supporting board 13.

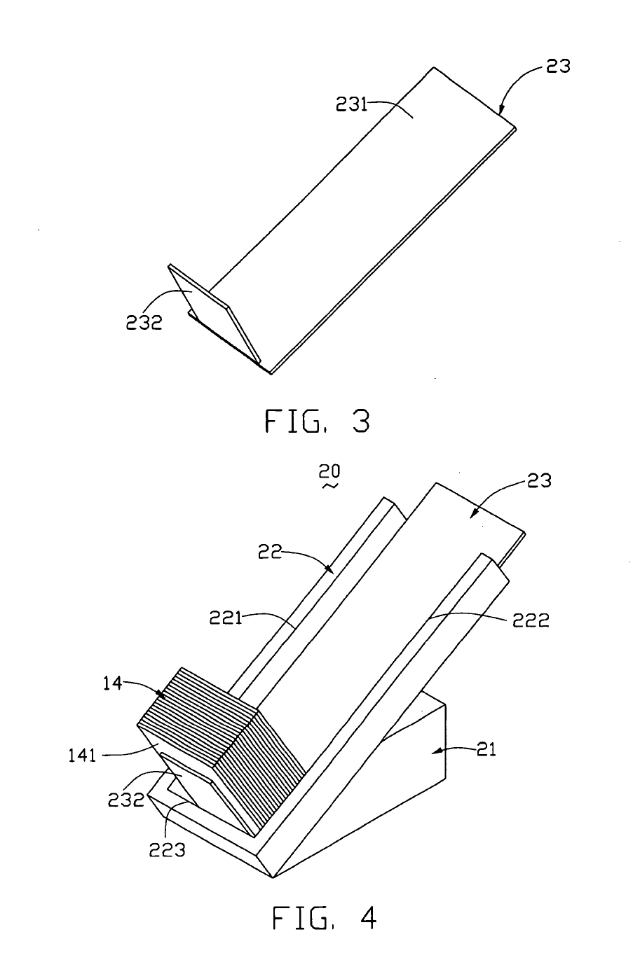

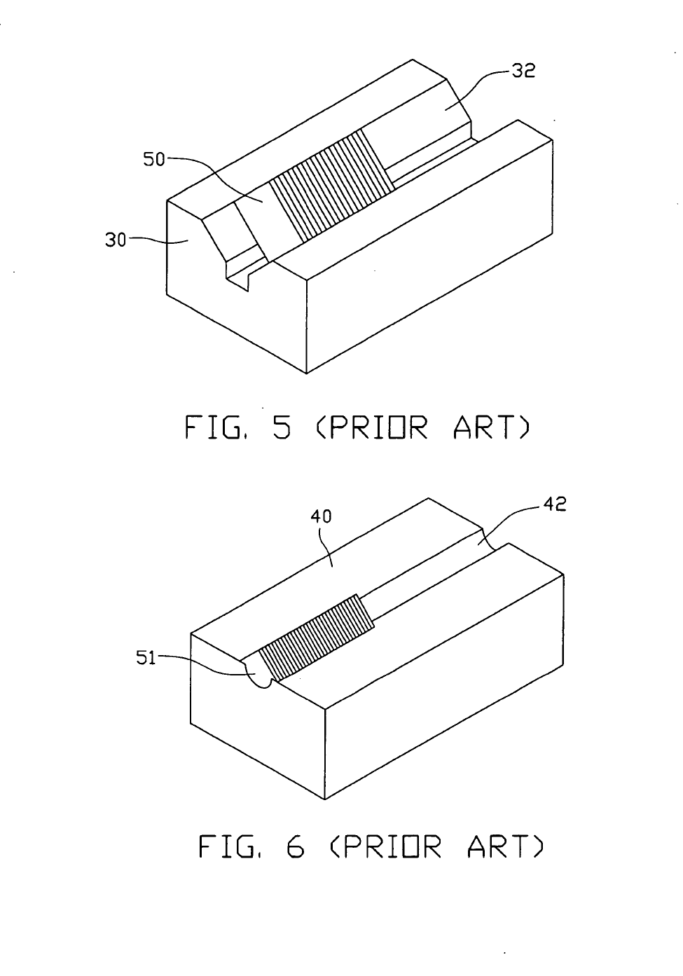

Referring to FIGS. 3-4, in another preferred embodiment a fixture 20 for bonding workpieces 14 includes a supporting base 21, a frame 22, and a supporting board 23. The supporting board 23 has a plane board 231 and a stopping board 232 vertical to the plane board 231. The stopping board 232 has a smaller width than the distance between a first side wall 221 and a second side wall 222, and has a higher height than that of a third side wall 223. The stopping board 232 contacts the third side wall 223 in a manner so as to prevent the workpieces 14 from falling out of the frame 22. If the hydrolysable ultraviolet adhesive is excessively applied, the stopping board 232 can also prevent the workpieces 14 from being bonded to the third side wall 223.

Understandably, the supporting base 11 can be substituted by an inclined board. The third side wall 123 can be higher than the other two side wall 121, 122, for preventing the workpieces 14 from turning out of the frame 12. The slideway 124 can also be substituted by other slide mechanisms so that the supporting board 13 can slidably contact the frame 12.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. A fixture for bonding workpieces, comprising:
a frame including a first side wall, a second side wall, and a third side wall, the first side wall being opposite to the second side wall, and the third side wall connecting the first side wall with the second side wall;
a supporting board slideably associated with the first side wall and the second side wall; and
a supporting base supporting the frame at a slanted angle relative to horizontal.

2. The fixture as claimed in claim 1, wherein the first side wall and the second side wall respectively have a slideway for guiding the supporting board.

3. The fixture as claimed in claim 2, wherein the slideways of the first side wall and the second side wall are opposite to each other.

4. The fixture as claimed in claim 2, wherein the supporting board is a quadrate board, and has a width slightly bigger than the distance between the first side wall and the second side wall.

5. The fixture as claimed in claim 1, wherein the first side wall is parallel with the second side wall.

6. The fixture as claimed in claim 1, wherein the third side wall is vertical to the first side wall and the second side wall.

7. The fixture as claimed in claim 1, wherein the supporting base has an inclined plane and an undersurface.

8. The fixture as claimed in claim 7, wherein the frame is settled on the inclined plane of the supporting base.

9. The fixture as claimed in claim 7, wherein the slant angel is in the range from 30 to 45 degrees.

10. The fixture as claimed in claim 1, wherein the supporting board has a stopping board vertically settled one side of the supporting board.

11. The fixture as claimed in claim 10, wherein the stopping board has a smaller width than the distance between the first side wall and the second side wall, and has a greater height than that of the third side wall.

12. A fixture for bonding workpieces, the fixture comprising:
a support member having a support surface inclined relative to a horizontal plane, the support surface being configured for supporting a plurality of bonding workpieces thereon, the support surface having a lower end portion and opposite first and second side portions;
a first and a second positioning members located at the first and second side portions, respectively, the first positioning member being parallel to the second positioning member, the support surface being slidable relative to at least one of the first and second positioning members; and
a third positioning member located at the lower end portion of the support member, wherein the support surface, the first, second and third members cooperatively form a receiving space therebetween for receiving the bonding workpieces therein.

13. The fixture as claimed in claim 12, wherein the first, second and third positioning members interconnect with each other so as to form a substantially U-shaped configuration.

14. The fixture as claimed in claim 12, wherein the third positioning member is integrated with the support member at the lower end portion thereof.

15. The fixture as claimed in claim 12, wherein the support surface is orientated perpendicularly to the bonding workpieces.

16. A fixture for a plurality of bonding workpieces, the fixture comprising:
a supporting member having a first positioning member and a second positioning member; and
a supporting board slidably positioned between the first positioning member and the second positioning member, the supporting board, the first and second positioning members cooperatively forming a space therebetween for receiving the bonding workpieces.

17. The fixture as claimed in claim 16, wherein the supporting member further comprises a third positioning member for positioning the supporting board.

18. The fixture as claimed in claim 17, wherein the first, second and third positioning members interconnect with each other so as to form a substantially U-shaped configuration.

19. The fixture as claimed in claim 16, wherein the supporting board is positioned at a slanted angle relative to a horizontal plane.

20. The fixture as claimed in claim 16, wherein the supporting board is detachable from the supporting member.
